(19) United States
(12) Patent Application Publication
(10) Pub. No.: US 2009/0283409 A1
(43) Pub. Date: Nov. 19, 2009

(54) Under-sink Apparatus for Target Pharmaceutical Compound Treatment

(76) Inventors: Tommy Stern, Flower Mound, TX (US); Todd McGee, Anthem, AZ (US)

Correspondence Address: Edward L. White, P.C., Suite B, 13924 Quail Pointe Drive, Oklahoma City, OK, 73134, US

(21) Appl. No.: 12/378,060

(22) Filed: Feb. 11, 2009

Related U.S. Application Data
(60) Provisional application No. 61/053,092, filed on May 14, 2008.

(51) Int. Cl. C02F 9/02; C02F 1/48; C02F 1/68; B01J 47/08

(52) U.S. Cl. 204/632; 210/198.1; 210/98; 210/259; 204/665; 210/173; 210/153

(57) ABSTRACT

A target compound treatment apparatus of a size capable of being mounted under a sink, the apparatus comprising a destruction zone in which an aqueous solution containing at least one target compound is exposed to a destruction agent adapted to convert the target compound into destruction byproduct; a filtration zone in which a filtration agent removes the destruction byproduct from the solution; and a flow inducer/pump adapted to cause the aqueous solution to flow through the apparatus. The destruction agent may comprise an acid, a base, an oxidizing agent, or a reducing agent. The destruction agent may be available on a surface of a solid substrate disposed within the destruction zone, or it may be available in a gaseous or liquid reagent that is admixed with the aqueous solution. The filtration agent may be comprised of an adsorption media such as activated carbon and/or other filtration means for removing destruction byproduct. The pump may be manually activated, or it may be activated by a sensor that detects a solution entering the apparatus.

### CROSS REFERENCES TO RELATED APPLICATIONS

This application is a continuation-in-part of provisional patent application No. 61/053,092 filed on May 14, 2008.

### BACKGROUND OF THE INVENTION

There is a need for a convenient way to dispose of drugs, injectables, and other pharmaceutical compounds in a way such that they do not contaminate waterways and/or eventually return to the public water supply. Wastewater contamination is an important issue, especially in hospital, dental, home care and other settings where pharmaceuticals are commonly discarded. Healthcare workers are known to dispose of pharmaceuticals incorrectly, often unintentionally, which can lead to contaminated waste water. Items that contain toxic chemicals are routinely poured down sinks. Since most waste water treatment facilities do not specifically treat for these chemicals, this can lead to pollution problem and to drugs making their way into public water supplies. In some instances, disposal of chemicals down sinks may lead to fines for violating EPA regulations.

The EPA has identified 1,500 publicly owned treatment works (“POTWs”) that are required to have a pretreatment program, and another 13,500 facilities that are not required to have a pretreatment program. Given the breadth of potential contaminants, the EPA focused on the following waste materials: mercury, primarily from dental facilities, but also from some medical equipment devices; and unused pharmaceuticals. Unused pharmaceuticals include animal and human drugs. Recent estimates are that over 200 million pounds of unused pharmaceuticals are dumped into the nation's wastewater system. They include wasted pills, excess liquid formulations (injectables and swallowed) and spilled biohazards. While the EPA and other regulators have best management practices in place, there is no measured data on the amount of unused pharmaceuticals entering POTWs. Current best management practices include: incineration or disposal in a solid-waste landfill. However, most pharmaceuticals are still disposed by being poured down a sink.

In its August 2008 Health Services Industry Study, EPA stated that, “52,089 hospitals and [other medical facilities] are potentially discharging spent pharmaceuticals” into the US water system, and “most of the facilities that discharge wastewater must discharge it indirectly to municipal sewer systems.” The report goes on to say that “a number of studies conducted over the past 10 years suggest detection of pharmaceutical compounds in treated wastewater effluent, streams, lakes, seawater, and groundwater, as well as in sediments and fish tissue.” The EPA is being pushed to solve this growing problem.

Common pharmaceuticals that are considered “hazardous wastes” under the Resource Conservation and Recovery Act (“RCRA”) include epinephrine, nitroglycerin, warfarin, nicotine, and many chemotherapy agents. These waste items are subject to unique and expensive disposal requirements, since the EPA regulates the generation, storage, transportation, treatment, and disposal of any pharmaceutical waste defined as hazardous waste by RCRA. The EPA is considering an expansion of these regulations by adding hazardous pharmaceutical waste to the Universal Waste Rule and published its intent in the Federal Register on Dec. 2, 2008. Hospitals and other health care providers in several states have faced significant fines associated with violations of RCRA and EPA requirements. Fine amounts can be large and vary by each state. Facilities in Nebraska, Minnesota, Florida, and other states have already been subject to inspections and subsequent fines, sometimes in excess of $100,000. For example, in early 2005, USEPA Region 2 (New York, New Jersey, the Virgin Islands, and Puerto Rico), noted that of the 480 hospitals in the region, 44 have been inspected to date, resulting in 22 enforcement actions. Nine formal enforcement actions resulted in proposed fines of more than $900,000 and six settlements were reached for a total of more than $400,000 in fines. The problem addressed by the present invention is large, and its priority to regulators is increasing and likely to continue rising in importance.

An article on the impact and risks of drugs in the water system was released by the Associated Press on Mar. 10, 2008. The story was picked up by CNN, USA Today, Fox News and many national and international papers. The Denver Post ran a follow up article on Sep. 11, 2008 confirming that municipalities are finding most of their systems have detectable levels of narcotics, hormones and other potentially dangerous contaminants. These articles have had the effect of energizing the public and lobbyists around the issue of water system safety. As a result, all the significant agencies are now working together to identify possible solutions and agree on best practices for handling drugs prior to or once in the water system.

A variety of treatment/processing options are available to treat wastewater containing unused pharmaceuticals. These processing options include chemical or physical adsorption, ion exchange, membrane filtration, electrodeionization, photo ionization, and other similar technologies. Treatment can include destruction of target compounds by exposing them to appropriate chemicals. Destruction can be accomplished by exposing organic materials to acids, bases, oxidizers, or reducing agents. Oxidizers, for example, may include peroxide, chlorine (gaseous or in solution), and various other chemicals.

Activated carbon, coal or resin beads remove oxidizers from a solution by a physical or chemical adsorption mechanism and remove dissolved organics by physical adsorption. Activated carbon can be used as granules or in monolithic block form.

Ion exchange works by exchanging hydrogen ions for cationic contaminants and hydroxyl ions for anionic contaminants in an aqueous solution. Ion exchange resin beds are made up of small beads through which the solution passes. After a period of time, cations and anions from the solution will replace most of the available hydrogen and hydroxyl sites in the resins and the resin bed will need to be replaced or regenerated. Ion exchange will only remove ionic compounds from the water. Dissolved organics can foul the ion exchange beads, decreasing their capacity. Where organically and inorganically pure water is needed, the combination of reverse osmosis or carbon filtration followed by ion exchange is particularly effective.

There are multiple names for filtration using microporous membranes including, but without limitation, microporous filtration, reverse osmosis (RO), ultra-filtration. All of these filtration technologies have in common the use of a membrane with tiny pores through which water may pass, but which prevents the passage of particles or solutes of a particular charge or size. Reverse osmosis is based on the fact that a chemical potential gradient can be eliminated by forcing a solution through a membrane. Water, driven by an osmotic pressure, a force caused by the concentration difference, passes through the membrane into the concentrated solution. The flow of water continues until the concentrated solution is diluted to approximately the same concentration as the formerly dilute solution (i.e., the chemical potential gradient is eliminated). If a pressure greater than the osmotic pressure is applied to the higher concentration side of the membrane, the normal direction of osmotic flow is reversed, pure water passes through the membrane from the concentrated solution and is thus separated from its contaminants. Membrane materials include, but are not limited to polyamide thin film and cellulosic membranes. Thin-film composite membranes are commonly used, but the materials of which they are comprised vary greatly. Ultra-filtration uses a membrane very similar in design to reverse osmosis, except that the ultra-filter pores are slightly larger, from 0.001 to 0.02 micron. The details of how to apply filtration using membranes will vary depending on the purity of effluent desired and the materials to be removed.

Electrodeionization (“EDI”) features a combination of ion exchange resin and ion-selective membranes. EDI is a refinement of electrodialysis (“ED”). The principle of ED is that water is purified in a cell containing two types of ion selective membranes (cation-permeable and anion-permeable) between a pair of electrodes. When an electric potential is applied across the cell, the cations in the water migrate towards the negatively charged cathode and the anions migrate towards the positively charged anode. The cations can pass through the cation-permeable membrane, but not through the anionic one and vice-versa. The net result is the movement of ions between chambers and the water in one section can become deionized while that in another section becomes concentrated. There is a practical limit to the purity than can be obtained by ED because of the prohibitively high electrical voltages required to drive ions through water of increasingly high purity. This problem is overcome in EDI technology by filling the spaces between the membranes with ion exchange resins. The resins provide a conductive flow path for the migration of ions, enabling deionization to be virtually complete and resulting in the production of high-purity water.

Photo-oxidation uses high intensity electromagnetic radiation (usually ultraviolet) to cleave and ionize organic compounds for subsequent removal by, for example, ion exchange cartridges. Radiation with a wavelength of 185 nm is most effective for the oxidation of organics.

### SUMMARY OF THE INVENTION

The present invention relates to disposal and/or destruction of drugs, injectables, and other pharmaceuticals. More particularly, the invention is an apparatus that destroys unused pharmaceuticals, then filters out the byproducts of the destruction process.

The invention may embody a target compound treatment apparatus comprising: (a) a destruction zone in which an aqueous solution containing at least one target compound is exposed to a destruction agent adapted to convert the target compound into destruction byproduct; (b) a filtration zone in which a filtration agent removes the destruction byproduct from the solution; and (c) a flow inducer adapted to cause the aqueous solution to flow through the apparatus. The destruction agent may comprise an acid, a base, an oxidizing agent, or a reducing agent, and it may be available on the surface of a solid substrate disposed within the destruction zone, the substrate either a granular or porous material. Alternatively, the destruction agent may be a liquid or gaseous reagent that is admixed with the aqueous solution upon activation of the apparatus by a sensor or by a user-operated switch. In addition to chemical destruction, the destruction may be accomplished by exposing the aqueous solution to a source of ionizing electromagnetic radiation.

The filtration agent may be an adsorption media such as activated carbon. In another embodiment, he filtration agent comprises a membrane adapted to allow water to pass but to prevent passage of destruction byproduct, such as an ion exchange bed or electrodeionization.

Due to the high pressure drop through the apparatus, a flow inducer is needed to maintain adequate flow rates through the apparatus. The flow inducer may comprise a pump at an either the inlet to the apparatus adapted to push the aqueous solution therethrough or at an outlet thereof.

The destruction zone and/or the filtration zone may be contained in at least one replaceable module. In one embodiment, both zones are contained in a single replaceable module. In this single-module embodiment, the destruction zone and filtration zones preferably have thicknesses calibrated such that they have the same treatment capacity, whereby they are spent and need replacement at the same time. In another embodiment, the destruction zone and filtration zones housed in separately replaceable modules.

The apparatus may include a pre-filter for preventing the entry of solid materials larger than a pre-determined size into the destruction zone. Another way of dealing with solids entering the apparatus is to provide a grinding zone adapted to pulverize any solid materials prior to their entry into the destruction zone.

In this specification, there are outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. Additional benefits and advantages of the present invention will become apparent in those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

### DESCRIPTION OF THE DRAWINGS

FIG. 1 is a schematic representation of a system incorporating the apparatus.

FIG. 2 is a top view of the apparatus.

FIG. 3 is a partial cross-sectional side view of a module.

FIG. 4 is a partial cross-sectional side view of a module having both a destruction and filtration zone.

FIG. 5 is a partial schematic representation of an apparatus incorporating a grinder for pulverizing larger solids placed into the apparatus.

### DETAILED DESCRIPTION

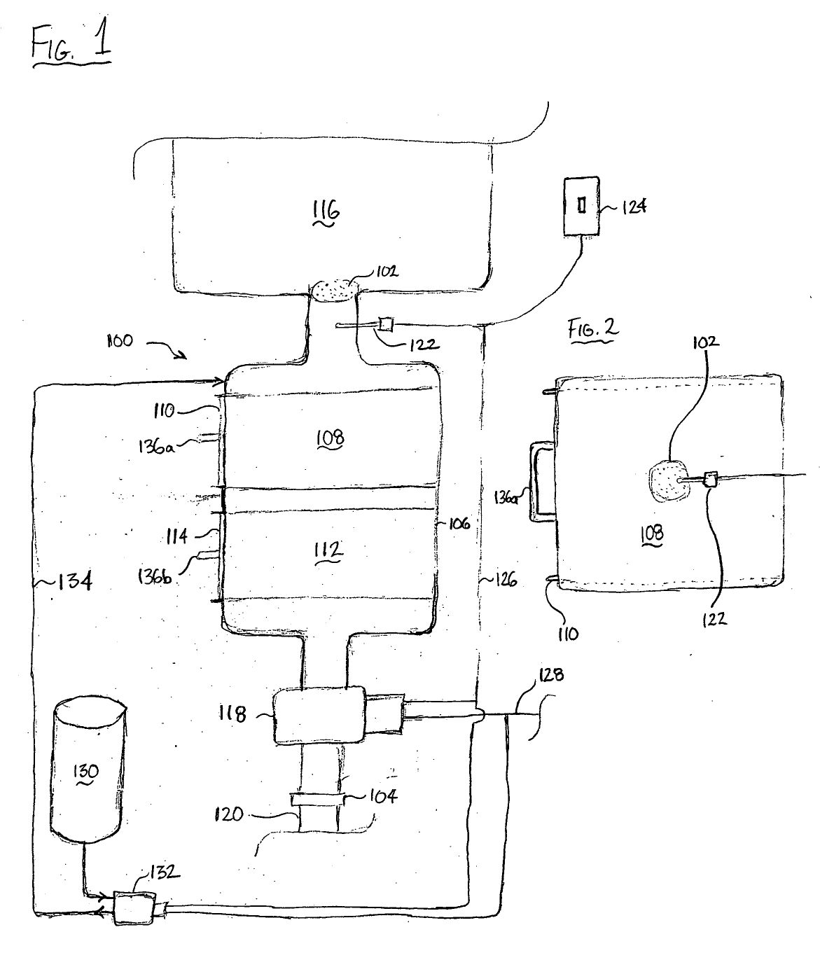

A target compound treatment apparatus 100 is shown schematically in FIG. 1. The apparatus 100 has an inlet 102, which is shown with an optional pre-filter/coarse screen. The apparatus 100 also has a body 106 terminating in an outlet 104. FIG. 1 shows the apparatus 100 having a square cross section. However, the exact cross section of the apparatus is not important: it could be round, oval, or any other cross section that is desired. Similarly, it is expected that the apparatus 100 will have a similar size to a standard under-sink garbage disposal. The size of the apparatus is not crucial to its novel function, but rather will be dictated by the space available and the desired life of the destruction and filtration zones. The smaller the size, the more frequently the various modules will have to be changed.

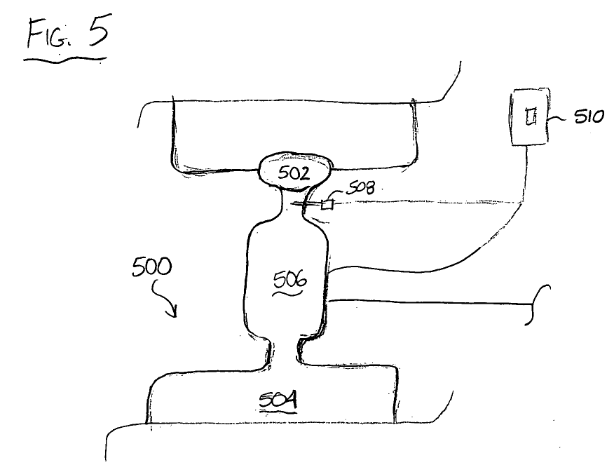

Within the body 106 are a destruction zone 108, shown as being contained within a first module 110, and a filtration zone 112, shown contained within a second module 114. Embodiments of the modules are further illustrated in FIGS. 3 and 4. FIG. 3 shows a single-zone module 300. The module 300 comprises a drawer with three watertight sides 302. The drawer shape is completed by a faceplate 304 having thereon a faceplate seal for sealingly engaging the body 106. Along an upper edge of the sides is a flange 308 with a flange seal 310 on an underside thereof. The flange 308 engages the body 106 to ensure that solution flowing down through the apparatus 100 passes through the destruction 108 and filtration zones 112 rather than bypassing them. Partial cross section shows the zone content material 314 for that module, which can either be the destruction zone materials or filtration zone materials, as discussed below. After passing though the materials 314, the solution passes out through a porous bottom 312. To assist with removal of the module 300, a handle 316 is shown affixed to the faceplate 304. Module handles 136 can also be seen in FIG. 1, which shows two separate modules, but which could also be equipped with a single module as illustrated in FIG. 4.

The module 300 may also have a means for securing the destruction zone 108 and/or the filtration zone 112 in place. The means for securing may include a lock with a key release or the like. The means for securing prevents any tampering with the modules by individuals who might desire to have access to unused pharmaceuticals or other chemicals contained therein.

FIG. 4 shows an alternative embodiment where both the destruction agent 414 and the filtration agent 418 are contained within a combined module 400. It again has a drawer 402 with three watertight sides cooperating with a faceplate 404 to form a drawer. Affixed to the faceplate 404 is a faceplate seal 406 for sealingly engaging the faceplate 404 to the body 106. A flange 408 is affixed to an upper edge of the drawer, the flange having a flange seal 410 on a lower surface for sealingly engaging a cooperating ridge within the body 106. The bottom of the drawer 402 has a porous bottom 412 to support the filtration agent 418. Disposed on top of the filtration agent 418 is the destruction agent 414. There may be a porous divider 422 (such as a screen or grate) disposed between the destruction agent 414 and the filtration agent 418, or they may simply rest upon one another. Depending on the target compound to be treated and the chemicals used to treat them, the destruction zone depth 416 will be varied with the object being depletion of both the destruction agent and the filtration agent at the same time. That is, the object will be to vary the depth of the materials to ensure that the times when both zones are used up is as close to the same as possible. Again, a handle 424 is shown affixed to the faceplate 404 to facilitate removal of the combined module 400.

The apparatus 100 will be mounted below a sink or basin 116. To ensure an adequate flow rate of solution through the apparatus 100, there is a flow inducer or pump 118. The pump 118 can be activated automatically by way of a sensor 122 or manually with a switch 124 in communication with the pump 118 by way of a control circuit 126. If a manual switch 124 is used, it can be either a wall switch such as is typically used for lights and the like, or it may be a foot pedal located adjacent to the apparatus 100. An “always on” option may be available for high-generation environments. The pump 118 may be battery-powered, but will preferably be powered by an external power source 128. In some embodiments it may be desirable to have both a switch and a sensor, as shown. Following the outlet 104, the apparatus is attached to a wastewater line 120 to accept solution flowing out of the apparatus 100.

Where, for example, the destruction agent is a liquid or gas, a chemical tank 130 may be needed to provide a storage reservoir. A pump or compressor 132 may be needed to move the chemical into the destruction zone 108 through a chemical supply line 134. Preferably, as shown, the chemical pump will also be powered by and controlled by the same control circuit 126 and power source 128 as the pump 118.

No tank 130 is needed if the destructive agent is a solid substrate as shown in FIG. 3 or 4. The solid substrate may be a bed of granular solids either comprised entirely of the destructive agent with the agent deposited at least on the surface of the granules. Alternatively, the solid substrate may be a porous matrix containing the destructive agent. If it is a porous matrix, the substrate may either be spongy, with the destructive agent therein, or a porous solid matrix either comprised of the destructive agent or having it at least on a surface thereof.

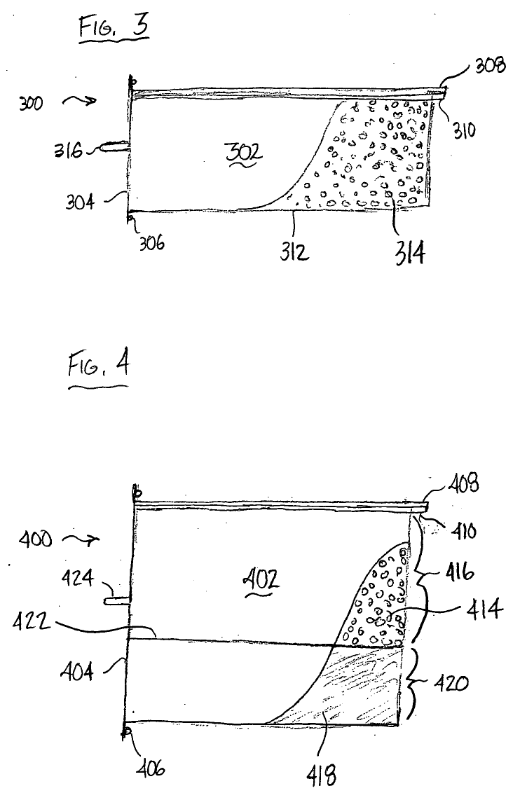

FIG. 2 is a top view of the apparatus. The inlet 102 is shown with a pre-filter to prevent coarse solids from entering. A module handle 136a can be seen. Also, a sensor 122 is shown at the inlet 102 for detection of solution entering the apparatus 100. A signal generated by the sensor 122 may activate the pump 118.

FIG. 5 shows an embodiment of the apparatus 500 incorporating a grinder 506. The grinder 506 is disposed between the inlet 502 and the body 504. The grinder 506 may be integrated onto the body 504. Preferably the grinder 506 is activated by the same sensor 508 or switch 510 that activates the pump 118. Alternatively, the grinder may have a separate switch for its activation.

While the invention has been shown, illustrated, described and disclosed in terms of specific embodiments or modifications, the scope of the invention should not be deemed to be limited by the precise embodiment or modification therein shown, illustrated, described or disclosed. Such other embodiments or modifications are intended to be reserved especially as they fall within the scope of the claims herein appended.

Thus having described the invention, I claim:

1. A target compound treatment apparatus comprising:
a. a destruction zone in which an aqueous solution containing at least one target compound is exposed to a destruction agent adapted to convert the target compound into destruction byproduct;
b. a filtration zone in which a filtration agent removes the destruction byproduct from the solution; and
c. a flow inducer adapted to cause the aqueous solution to flow through the apparatus;
whereby, the target compound is first converted to byproduct, then the byproduct of that conversion is filtered out of the solution, preventing target compounds from entering wastewater systems and ultimately re-entering the water supply.

2. The apparatus of claim 1, the destruction agent comprising an acid, a base, an oxidizing agent, or a reducing agent.

3. The apparatus of claim 1, the destruction agent available on at least the surface of a solid substrate disposed within the destruction zone.

4. The apparatus of claim 3, the substrate comprising granular matrix.

5. The apparatus of claim 3, the substrate comprising a porous material.

6. The apparatus of claim 1, the destruction agent available in a liquid reagent that is admixed with the aqueous solution.

7. The apparatus of claim 6, the admixing of the reagent being accomplished by mechanical injection of the reagent into the solution upon a sensor detecting the solution entering the apparatus.

8. The apparatus of claim 6, the admixing of the reagent being accomplished by mechanical injection of the reagent into the solution upon activation of the apparatus by an operator.

9. The apparatus of claim 1, the destruction agent comprising exposing the aqueous solution to a source of ionizing electromagnetic radiation.

10. The apparatus of claim 1, the destruction agent comprising a gaseous destruction agent mixed with the solution.

11. The apparatus of claim 1, the filtration agent comprising an adsorption media.

12. The apparatus of claim 11, the adsorption media comprising activated carbon.

13. The apparatus of claim 1, the filtration agent comprising a membrane adapted to allow water to pass but to prevent passage of destruction byproduct.

14. The apparatus of claim 1, the filtration agent comprising an ion exchange bed.

15. The apparatus of claim 1, the filtration agent comprising electrodeionization.

16. The apparatus of claim 1, the flow inducer comprising a pump at an inlet to the apparatus adapted to push the aqueous solution therethrough.

17. The apparatus of claim 16, the pump being activated by a sensor that detects when an aqueous solution enters the apparatus.

18. The apparatus of claim 1, the flow inducer comprising a pump at an outlet of the apparatus adapted to pull the aqueous solution therethrough.

19. A target compound treatment apparatus comprising:
a. a destruction zone in which an aqueous solution containing at least one target compound is exposed to a destruction agent available on at least the surface of a solid substrate, the destruction agent adapted to convert the target compound into destruction byproduct;
b. a filtration zone containing a layer of filtration agent adapted to remove the destruction byproduct from the solution; and
c. a pump at an outlet of the apparatus adapted to pull the aqueous solution through the apparatus;
whereby, the target compound is first converted to byproduct, then the byproduct of that conversion is filtered out of the solution, preventing target compounds from entering wastewater systems and ultimately re-entering the water supply.

20. The apparatus of claim 19, both the destruction zone and the filtration zone contained in at least one replaceable module.

21. The apparatus of claim 20, the filtration agent comprising activated charcoal.

22. The apparatus of claim 20, the pump activated by a sensor that detects when an aqueous solution enters the apparatus.

23. The apparatus of claim 19, wherein the destruction agent is an acid, a base, an oxidizing agent, or a reducing agent.

24. The apparatus of claim 19, both the destruction zone and the filtration zone contained in a single replaceable module.

25. The apparatus of claim 24, the destruction zone and filtration zones having thicknesses calibrated such that they have the same treatment capacity, whereby they are spent and need replacement at the same time.

26. The apparatus of claim 19, the destruction zone and filtration zones housed in separately replaceable modules.

27. The apparatus of claim 19 further including a pre-filter for preventing the entry of solid materials larger than a pre-determined size into the destruction zone.

28. The apparatus of claim 19 further including a grinding zone adapted to pulverize any solid materials prior to their entry into the destruction zone.

29. A target compound treatment apparatus comprising:
a. a housing through which fluid may pass, the housing adapted to be mounted under a sink drain;
b. at least one replaceable module removably inserted into the housing containing
i. a destruction zone in which an aqueous solution containing at least one target compound is exposed to a destruction agent available on at least the surface of a solid substrate, the destruction agent adapted to convert the target compound into destruction byproduct, and
ii. a filtration zone in which a filtration agent removes the destruction byproduct from the solution; and
c. a pump at an outlet of the apparatus adapted to pull the aqueous solution through the apparatus and allow it to pass out through a wastewater line;
whereby, the target compound is first converted to byproduct, then the byproduct of that conversion is filtered out of the solution, preventing target compounds from entering wastewater systems and ultimately re-entering the water supply.

30. The apparatus of claim 29, wherein the destruction agent is an acid, a base, an oxidizing agent, or a reducing agent.

31. The apparatus of claim 30, the module secured in place by a releasable lock means for securely maintaining the module in place.
